(19) United States
(12) Patent Application Publication
(10) Pub. No.: US 2015/0089638 A1
(43) Pub. Date: Mar. 26, 2015

(54) SMART METER SECURITY SYSTEM AND METHOD

(71) Applicant: INTERNATIONAL BUSINESS MACHINES CORPORATION, Armonk, NY (US)

(72) Inventors: John M. Cohn, Richmond, VT (US); Eren Kursun, New York, NY (US); Maharaj Mukherjee, Poughkeepsie, NY (US); Anna Topol, Jefferson Valley, NY (US)

(73) Assignee: INTERNATIONAL BUSINESS MACHINES CORPORATION, Armonk, NY (US)

(21) Appl. No.: 14/036,175

(22) Filed: Sep. 25, 2013

(51) Int. Cl. H04L 29/06

(52) U.S. Cl. CPC H04L 63/1441
USPC 726/22

(57) ABSTRACT

A system, method and computer program product for protecting utility usage information from utility company users, e.g., power company endpoints. Smart meters monitor endpoint service usage to identify the start of a critical usage period. During critical usage periods the smart meters select and modulates a generic usage pattern by the difference between the pattern and actual usage. Instead of sending actual usage data, the smart meter sends the modulated generic usage pattern to the service provider. The service provider extracts the deltas and determines endpoint service usage from the extracted deltas.

### CROSS REFERENCE TO RELATED APPLICATION

The present invention is related to U.S. patent application Ser. No. 13/______ (Attorney docket No. YOR920130458US1), “ENDPOINT LOAD REBALANCING CONTROLLER” to John M Cohn et al., filed coincident herewith, assigned to the assignee of the present invention and incorporated herein by reference.

### BACKGROUND OF THE INVENTION

1. Field of the Invention

The present invention is related to information security and more particularly to differential power analysis and other side channel attacks (SCA).

2. Background Description

Increasingly, utility companies are deploying endpoint monitoring devices, known as smart meters, grid health sensors, and data concentrators, that monitor local endpoint power consumption and periodically report usage. As of 2010 there were eight (8) million smart meters deployed with as many as sixty (60) million expected to be deployed by 2020. Security and privacy is of great concern both personally and in the business-place. Consequently, smart endpoint devices have become security attack targets. Utility companies have employed encryption based design techniques to provide some security for smart meter communications.

So for example, to prevent brute force security attacks on smart grid endpoints, some state of the art designs have incorporated encryption standardized in Advanced Encryption Standard (AES), e.g., AES-128,256. Some of these protection techniques are directed at preventing endpoint cryptographic key extraction. Others prevent reverse-engineering endpoint communication protocols. Since not all smart endpoint device communication is encrypted, providers have deployed meter reprogramming with embedded security technology, derived from financial transactions and government applications. Some embedded products have physical attack-detection mechanisms. Other embedded products rely on deployed logical techniques like lockable and encrypted, secure on-chip memories. Still other approaches rely on secure bootloaders that lock the endpoint device during manufacturing. Whenever financial or political incentives have aligned, however, someone has quickly developed some method, e.g., data mining technique, to exploit any available data.

In spite of employing these security measures, using smart meters has added privacy and security vulnerabilities to what are commonly known as side channel attacks, which may reveal key information in spite of security efforts. For example, a smart meter may store or cache energy use information before reporting it to the service provider. State of the art smart meters monitor power consumption with a high resolution level, e.g., to the minute or even second. Stored information is an information-rich side channel, that characterizes customer habits and behaviors.

Some activities have detectable power consumption signatures, e.g., watching television. Even detecting the presence or absence of activity can provide some information. Side channel attacks frequently use energy profiling to extract available consumption signatures, and exploit vulnerabilities that are beyond protection with encryption. Typical energy profiling includes, for example, Differential Power Analysis (DPA) and Differential Electromagnetic Analysis (DEMA), and also invasive attacks (e.g. laser attacks). Information embedded in power consumption data, increasingly, has made utility companies a potential source of privacy abuse by side channel attackers. Consequently, side channel attacks have raised privacy and security concerns both for home and business and concern for side channel attack vulnerability has been increasing, not only from the customer information privacy perspective but also for enterprise applications.

Thus, there is a need for side channel attack security/prevention for protecting service facility infrastructure, and for focusing security on differential power and EM side channel attacks in smart meters and on preventing the attacks, and especially on smart meters metering and monitoring utility usage such as electricity, gas, water, fuel and other commodities.

### SUMMARY OF THE INVENTION

A feature of the invention is improved prevention of usage data based security breaches;

Another feature of the invention is side channel attack protection for smart meters;

Yet another feature of the invention is side channel attack protection for preventing differential power and EM side channel attacks in smart meters;

Yet another feature of the invention is side channel attack protection for preventing differential power and EM side channel attacks in smart meters metering and monitoring electricity, gas, water, fuel and other commodities.

The present invention relates to a system, method and computer program product protecting utility usage information from utility company users, e.g., power company endpoints. Smart meters monitor endpoint service usage to identify the start of a critical usage period. During critical usage periods the smart meters select and modulates a generic usage pattern by the difference between the pattern and actual usage. Instead of sending actual usage data, the smart meter sends the modulated generic usage pattern to the service provider. The service provider extracts the deltas and determines endpoint service usage from the extracted deltas.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a typical location with area supplier infrastructure, e.g., power company infrastructure, serving the location, according to a preferred embodiment of the present invention;

FIG. 2 shows an example of a block diagram example of a preferred smart meter, e.g., as a system on a chip;

FIGS. 3A-D show an example of raw customer data and reported data;

FIGS. 4A-B show an example of a preferred system using a two-phased approach, first masking actual power dissipation periods with representative predetermined usage pattern templates, and second identifying masked periods for extracting billing information;

FIG. 5 shows an example of an original power consumption signal monitored by an enterprise end preferred smart meter and a signal with critical activity shielded.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

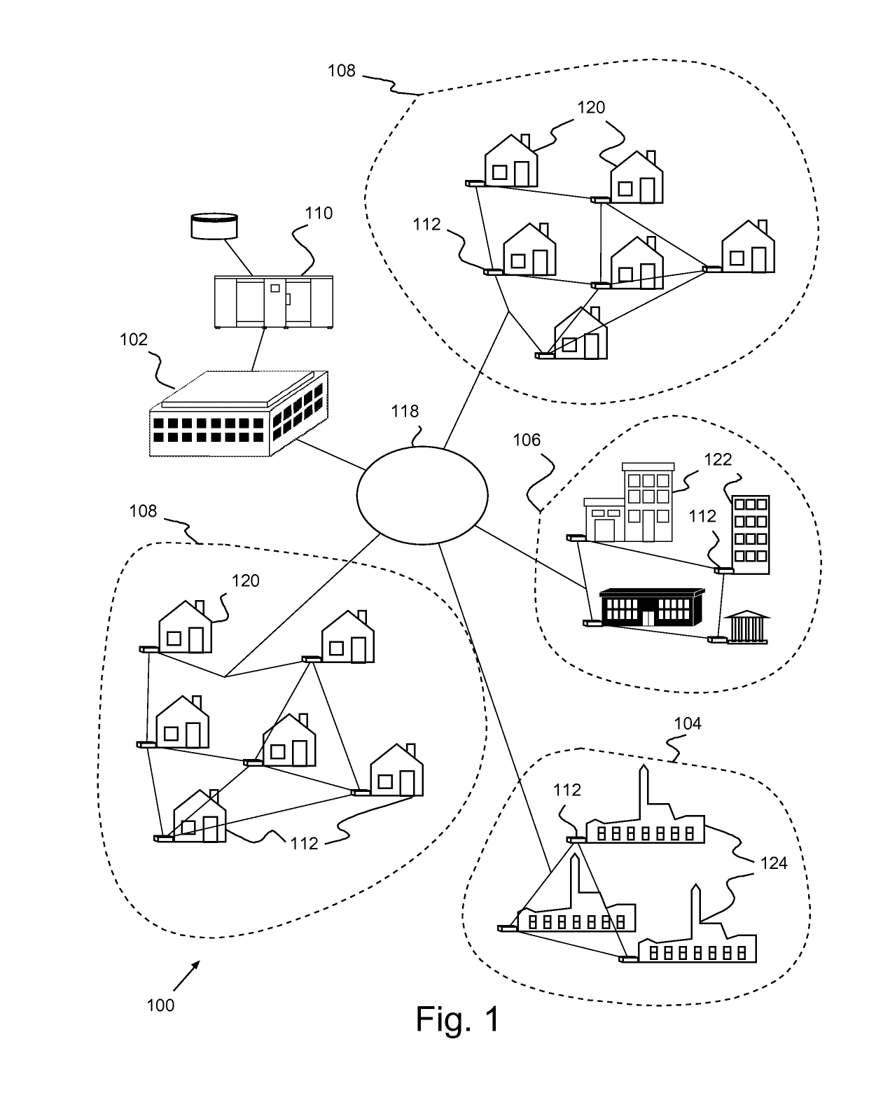

Turning now to the drawings and more particularly, FIG. 1 shows an example of a typical location 100 with area supplier infrastructure, e.g., power company 102 infrastructure, serving the location 100. A typical location 100 as in this example includes industrial zones 104, commercial zones 106 and residential zones 108. Supplier infrastructure includes one or more computer 110 receiving local usage information from local smart meters 112 monitoring power grid 118 usage of supplier provided services, e.g., power used at individual residences 120, commercial consumption at office buildings 122 and industrial consumption at local plants 124.

Previously, side channel attackers created detailed profiling capabilities to exploit hidden information embedded in available high resolution usage data. Burglars could use energy profiling, for example, to extract information to determine a homeowners comings and goings, e.g., vacancies both daily (e.g., work schedules) and extended (e.g., vacations).

Similarly, an industrial spy could have used energy profiling with more serious implications for an enterprise customer. The spy could use the business's power dissipation profile(s) to reveal critical information on enterprise activity, even minute to minute activity. For example, using the proper analysis tools, one can extract critical information buried in a bank's power usage, information such as trading scheme timing, trading duration, trading activity start and end, and trading patterns. Power dissipation patterns may hold key manufacturing process information, trading algorithms and/or security vulnerability. If, a side-channel attacker identifies daily/weekly activity patterns an attacker can, for example, customize attacks to the activity patterns.

Thus, each preferred smart meter 112 continually streams data to the service provider, masking critical data periods with generic power usage patterns. Each smart meter 112 maintains and uses a library, e.g., in local storage, of pre-determined generic power usage patterns. Instead of periodically sending a detailed breakdown of actual power use to the utility company 100 computer(s) 110, the smart meter 112 selects and sends one of the pre-determined generic power usage patterns, thereby preventing energy profiling and side-channel attacks.

It is understood that although described for smart meters monitoring power usage, the present invention has application to data concentrators and other units for collecting metered information; and, anywhere that side channel attack vulnerabilities pose a threat to information security, personal, private and/or public. Moreover, the present invention has application beyond electric (smart) grids and related components, such as for metering and monitoring gas, water, fuel or other commodities.

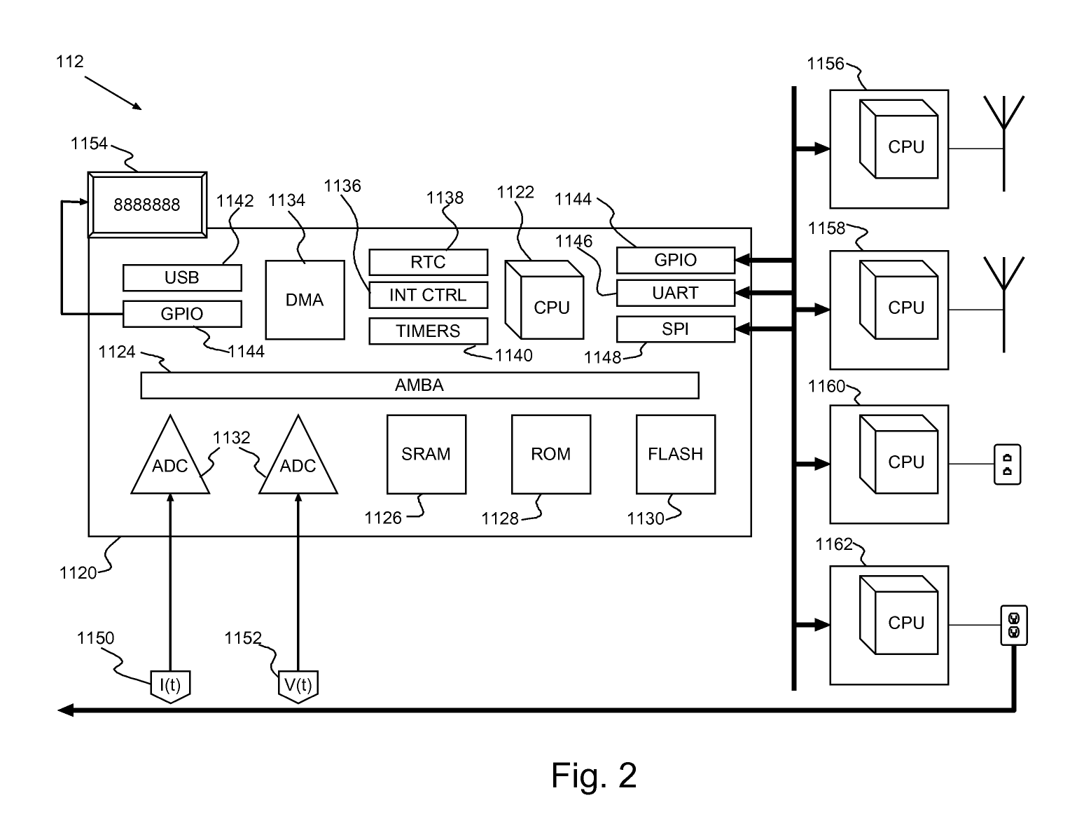

FIG. 2 shows a block diagram example of a preferred smart meter 112, e.g., as a system on a chip 1120. Preferably, the core chip is based on an Advanced Reduced Instruction Set Computer (RISC) Machines (ARM) processor 1122 using Advanced Microcontroller Bus Architecture (AMBA) 1124 for on-chip functions communications. In addition a preferred chip 1120 may include, for example, storage 1126, 1128, 1130, analog to digital converter (ADCs) 1132, a micro direct memory access (μDMA) controller 1134, an interrupt controller 1136 and timing 1138, 1140 and various input/output (I/O) controllers/ports 1142, 1144, 1146, 1148.

In this example, the storage includes random access memory (RAM) 1126, read only memory (ROM) 1128 and flash memory 1130, storing instructions, data and generic power usage patterns as appropriate. The RAM 1126, preferably, is static RAM (SRAM). Timing includes a real time clock (RTC) 1138 and general-purpose timers 1140. The I/O ports in this example include a universal serial bus (USB) port 1142, two (2) general-purpose I/O (GPIO) ports 1144, a universal asynchronous receiver/transmitter (UART) 1146 and a system packet interface (SPI) 1148.

A current sensor 1150 senses local current use and a voltage sensor 1152 senses local voltage fluctuations. Each of the sensors 1152 is connected to an ADC, with data from both used for determining power local power use. A local display 1154, e.g., a seven (7) digit liquid crystal diode (LCD) display, indicates instantaneous power consumption. Communications processors, e.g., suitably enabled ARM processors, provide external communications capabilities and may be on the same chip 1120 or, as in this example, capabilities separate from the system chip 1120. Thus, in this example, external communications include a wireless local area network (WLAN or WiFi) capability 1156, a Zigbee data communications capability 1158, a cellular or wired modem capability 1160 and/or a power line network capability 1162.

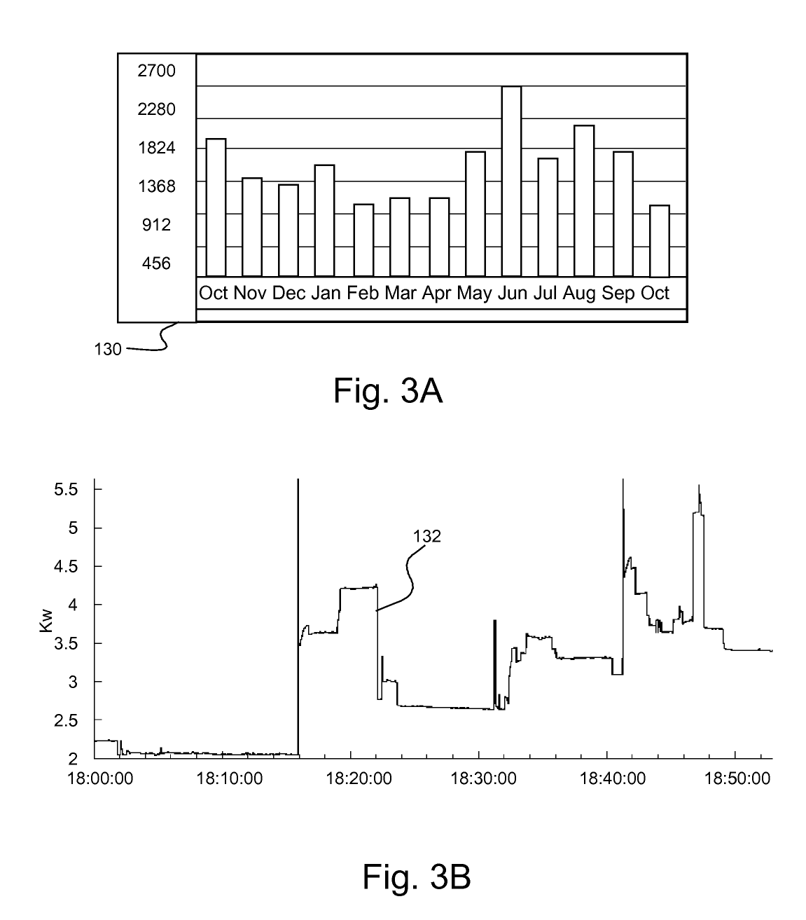

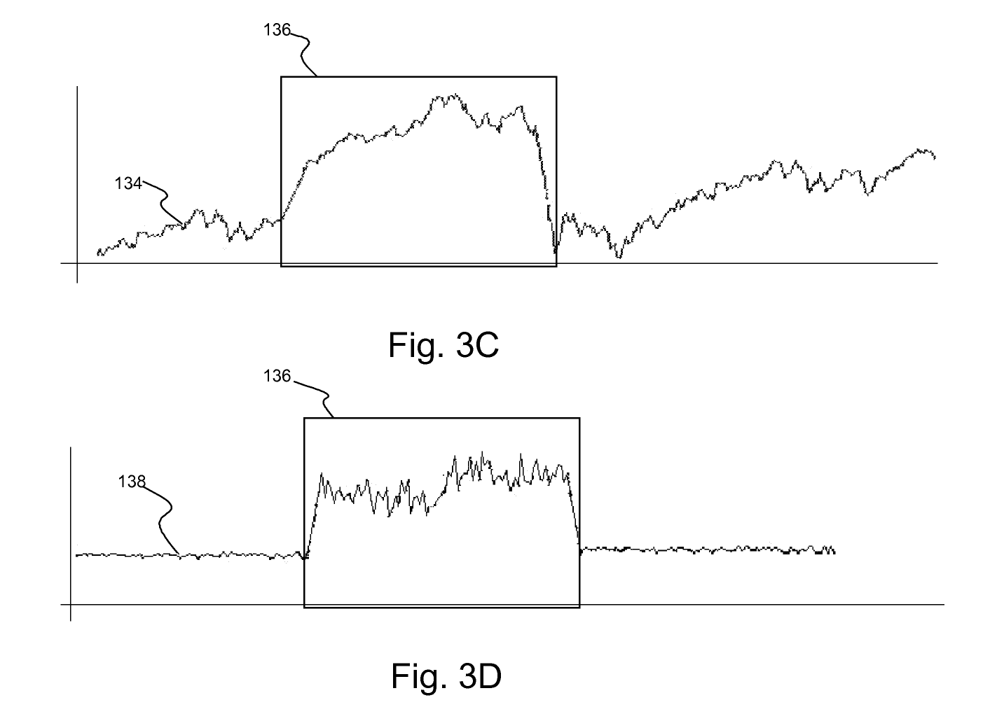

FIGS. 3A-D show an example of raw customer data and reported data. Thus, FIG. 3A shows an example of a customer consumption report 130 provided from a power company indicating cumulative monthly power consumption in kilowatt hours (kWh). As shown in FIG. 3B, however, a preferred smart meter, e.g., 112, may measure 132 instantaneous power use, typically sampling power (kW) minute by minute. So as shown in FIG. 3C, end node consumption data 134 collected, e.g., from a bank, by a smart meter may have some ambient level, with server power being observable during peak trading periods 136. Moreover, that server power may be extracted 138 from the raw data as shown in FIG. 3D.

Thus, a side channel attacker can determine server activity from the raw data. By observing the beginning of the critical activity in smart metered power patterns or by observing equipment close to the end-node, activity patterns may indicate, for example, a trading activity period in the bank. An attacker can determine, for example, the bank's schedule and trading patterns, e.g., trading between 9:15-10:00 am and 2-3 pm. Encryption provides inadequate protection for shielding against this kind of attack.

However, a preferred system shields actual usage with predetermined usage pattern templates, previously selected/agreed upon with the utility company. The utility company specially selects patterns that signal trends and key information about the usage profile, while completely concealing actual power usage details. As a result the side-channel attacker reads incorrect information and patterns while the end-user and utility company communicate through the patterns.

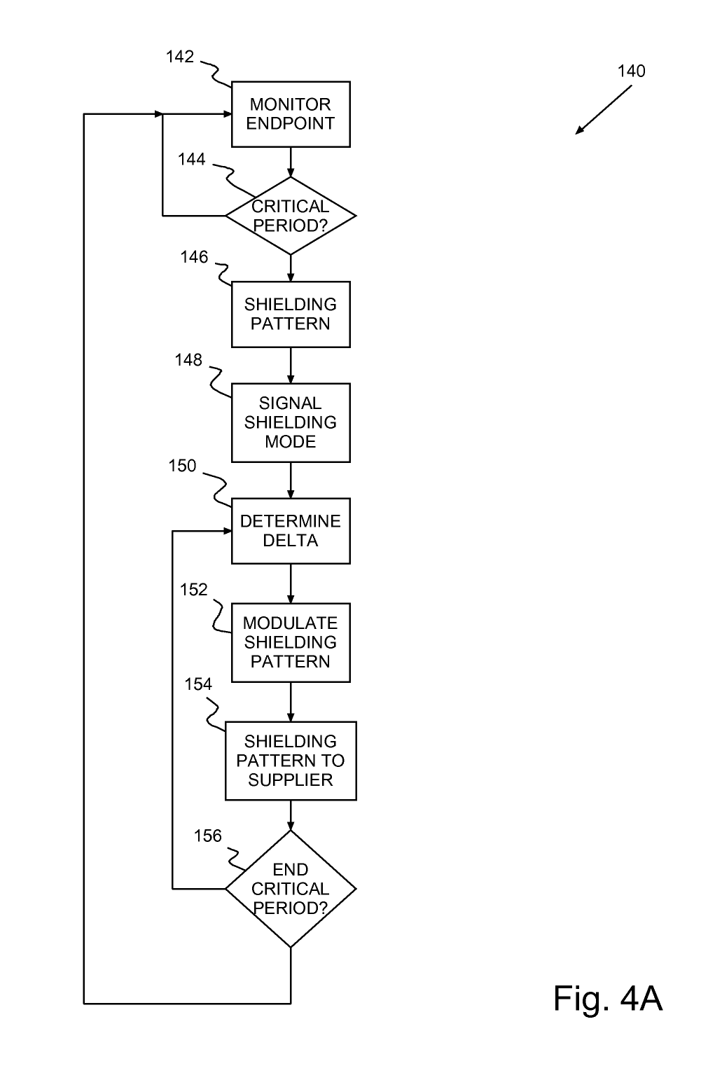

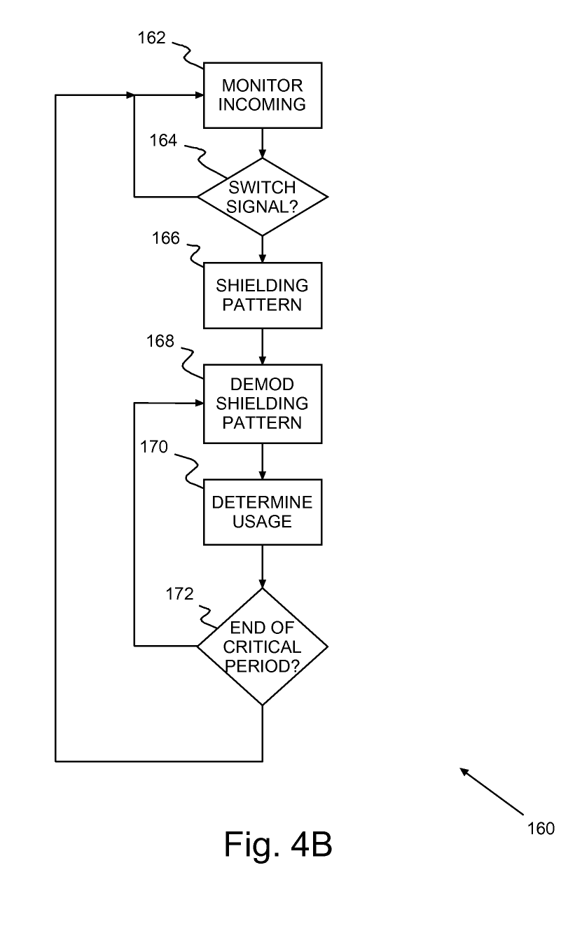

As shown in FIGS. 4A-B, a preferred system uses a two-phased or bifurcated approach. First a preferred smart meter at one end (e.g., 112 in FIGS. 1 and 2) masks data 140, identifying a predetermined generic usage pattern template and shielding actual power dissipation periods in a shielding pattern generated from the template. Second, at the other end, the service provider unmasks data 160, identifying shielded periods and extracting usage information from the shielding pattern, e.g., for billing.

The preferred smart meter 112 monitors activity 142 until it detects 144 critical user activity periods, e.g., by usage passing a preselected high or low limit, or passing a power threshold. When the smart meter 112 identifies critical activity enters shielding mode and begins providing special protection. During those periods 140, e.g., bank trading periods or high power activity in manufacturing plants, the smart meter 112 selects a predetermined template pattern 146 as a shielding pattern template. Then, the smart meter 112 signals selected shielding pattern template and the switch to shielding mode 148 to supplier infrastructure, e.g., over a network to computer(s) 110. While in shielding mode, the smart meter 112 extracts an estimated pattern of actual usage and modulates the selected shielding pattern template to create a corresponding shielding pattern. Instead of sending actual power usage information, the smart meter 112 sends the shielding pattern, which obfuscates large actual usage variations in the data stream reported to the provider.

So, in shielding mode the smart meter 112 generates time slice deltas 150 that approximate actual usage, where each delta is the periodic difference between the actual raw data pattern and the selected shielding template. The smart meter 112 uses the deltas to modulate 152 the shielding template in magnitude and time. Then, instead of sending the true, monitored, or raw, data, the smart meter 112 sends 154 the modulated template as a shielding pattern to supplier infrastructure, e.g., computer(s) 110, until the critical period ends 156. When the critical period ends 156, the smart meter 112 signals the end, returns to monitoring 142 and forwards random or unaltered usage data.

Between critical activity periods the smart meter 112 may forward unaltered data until critical activity begins. Preferably, however, the smart meter generates random usage patterns within normal usage parameters and forwards those random usage patterns until critical activity begins. When local consumption either rises above, or falls below, a preset limit up, the smart meter 112 sends a shielding pattern to maintain online activity that counteracts any apparent power consumption variation. The shielding pattern masks overall consumption variation, such that apparent consumption remains unchanged over the time, hiding information that an attacker might otherwise locate and extract to reveal critical business activity. As a result, any side channel attacker observing consumption patterns would fail to detect any abrupt consumption variations.

Optionally, the power information may be encrypted using a standard encryption technique, preferably, after modulation to additional protection, concealing absolute data values. Standard encryption further shields highly critical activity making enterprise end activity unobservable and unavailable to side channel attackers. With or without encryption, however, the modulated pattern 154 provides stronger protection for the underlying energy usage information than just encryption alone provides.

Encryption alone may not conceal, for example, high activity periods, the start and end of high activity periods, and other key information (such as from frequency of communication). By contrast modulating known generic patterns, modulating either or both of amplitude and length in each time slice through the actual power usage period, guarantees protection from side-channel attacks. Further, modulation caps may be set for maximum and minimum activity level values and pattern characteristics. Thus modulating generic usage during selected power activity periods, completely conceals power activity and inactivity, as well, providing security both for a vacationing household end-user, and for of an enterprise user concerned with preventing power profiling, e.g., to prevent and attacker from extracting trading schedules, activity details and start-end times.

Unmasking data 160 at the supplier infrastructure end, in this example at computer 110, begins with the supplier monitoring 162 incoming activity data from smart meters 112 for switch signals that indicate a respective smart meter 112 has switched to shielding mode. When the infrastructure computer 110 detects a mode switch signal 164, the computer 110 determines 166 which stored generic pattern to use as a substitution template pattern for extracting usage information. Then, the infrastructure computer 110 determines 168 the difference between the substitution template and the shielded information from the endpoint. From this the infrastructure computer 110 demodulates the pattern data 168 to extract the deltas and regenerate 170 an approximation of the raw signal. The demodulation 168 and regeneration 170 continues until reaching the critical activity period ends 172. When the infrastructure computer 110 receives an end signal 172 from the originating endpoint, normal monitoring 162 resumes.

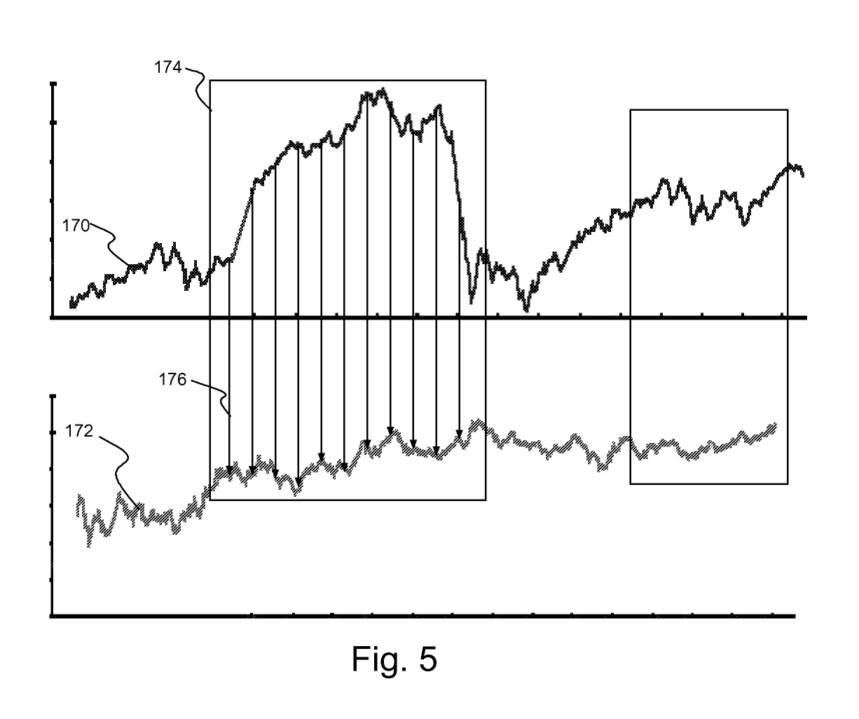

FIG. 5 shows an example of an original power consumption signal 180 monitored and collected at an enterprise end by preferred smart meter, e.g., 112 in FIGS. 1 and 2, and a signal 182 with critical activity shielded in step 150 of FIG. 4A. At the beginning of window 184, the smart meter 112 detects 144 critical activity, switches to shielding mode, and selects 146 shielding template. After signaling the switch to shielding mode 148 to notify the supplier, the smart meter 112 begins sending the shielding pattern. The smart meter 112 determines a time slice delta 150 from the difference between the original signal 180 and the resulting shielded pattern 182, periodically, indicated by arrows 186. The smart meter 112 uses the time slice deltas to modulate 152 the shielding template 182 in magnitude and time and transmits 154 the modulate shielding signal until the critical activity period ends 156, at the end of window 184 in this example.

Between critical periods 184, both before and after, e.g., in window 188, random usage pattern generation fills the gaps with false activity profiles. As the supplier is previously informed of the selected shielding template, the supplier can identify the modulating pattern or deltas. By deconstructing the modulated pattern to arrive at the shielding template, each difference provides a delta. Then, the supplier easily filters out gap fillers between critical periods, in this example at computer 110 and/or later smart grid stages. Since the supplier infrastructure is aware of the selected shielding template, while a side channel attacker is not, the side channel attacker perceives the modulated template and gap fillers as actual data.

Advantageously, communications security according to a preferred embodiment of the present invention focuses on differential power and electromagnetic (EM) attacks and securing from side channel attacks in smart meters. The present invention is compatible with existing data encryption services and devices to add protection from side channel attacks. Thus, because there is no simple encryption key to break to access power information and patterns, facility customers' have reduced vulnerability to a nefarious tapping. Side channel attackers cannot detect periods of high activity or inactivity because there are no observable usage pattern changes. Since side channel attackers observe a normal looking usage pattern, even during periods when customers are active, the attackers' have little motive for expending efforts for more in-depth side channel observations. Even so, the provider end receives complete usage data, securely transmitted for better managing and supplying provider capabilities and services, e.g., over a smart grid.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

1. A security method for protecting service usage information comprising:
monitoring service usage at an endpoint;
identifying the start of a critical usage period;
selecting a generic usage pattern;
notifying a service provider of said start and the selected said generic usage pattern;
determining a delta between said selected generic usage pattern and actual usage;
communicating said selected generic usage pattern to said service provider, said delta being periodically communicated with said selected generic usage pattern; and at the end of said critical usage period
returning to monitoring service usage.

2. A security method as in claim 1, wherein between critical usage periods said method further comprises communicating a random generic usage pattern.

3. A security method as in claim 2, wherein selecting said generic usage pattern comprises selecting said generic usage pattern from a plurality of stored generic usage patterns; and
communicating said random generic usage pattern comprises generating said random generic usage pattern.

4. A security method as in claim 1, wherein periodically communicating said delta comprises modulating said selected generic usage pattern with said delta in time and magnitude.

5. A security method as in claim 1, further comprising:
receiving said start notification;
identifying said selected generic usage pattern;
extracting periodically communicated deltas from the communicated identified generic usage pattern; and
determining service usage at said endpoint from extracted said deltas.

6. A security method as in claim 5, wherein said service provider is a power company and said method further comprises:
monitoring communications from endpoints;
parsing received communications until said start notification is identified, said periodically communicated deltas being extracted until an end of said critical usage period is reached; and
returning to monitoring communications from said endpoint.

7. A security method as in claim 6, wherein at said end of said critical usage period said method further comprises:
notifying said service provider of said end of said critical usage period; and
communicating a random generic usage pattern to said service provider.

8. A security method for protecting utility usage information from utility company users, said security method comprising:
monitoring communications from endpoints;
identifying in monitored communications a start notification indicating the start of a critical usage period at a user endpoint;
identifying an indicated generic usage pattern being communicated from said user endpoint for the duration of said critical usage period;
extracting periodically communicated deltas from communications from said user endpoint; and
determining service usage at said endpoint from extracted said deltas.

9. A security method as in claim 8, wherein identifying said start notification in monitored communications comprises parsing monitored communications until a start notification signal is identified, said generic pattern being indicated with said start notification signal.

10. A security method as in claim 9, wherein periodically communicated deltas are extracted from said communications from said user endpoint until the end of said critical usage, said method further comprising:
identifying in said communications from said endpoint an end signal indicating said end of said critical usage, said end signal notifying said utility company of said end of said critical usage period; and
returning to monitoring said communications from endpoints including communications from said endpoint.

11. A security method as in claim 10, wherein after said end signal is identified, said utility company ignores content of said communications from endpoints until a next start notification signal is identified.

12. A security method as in claim 8, further comprising each of said endpoints:
monitoring service usage;
identifying the start of a critical usage period;
selecting a generic usage pattern;
communicating said start notification and the selected said generic usage pattern to said service provider;
determining said delta between said selected generic usage pattern and actual usage;
communicating said selected generic usage pattern to said service provider, said delta being periodically communicated with said selected generic usage pattern; and at the end of said critical usage period
returning to monitoring service usage.

13. A security method as in claim 12, wherein said service provider is a power company, and between critical usage periods said method further comprises communicating a random generic usage pattern.

14. A security method as in claim 13, wherein selecting said generic usage pattern comprises selecting said generic usage pattern from a plurality of stored generic usage patterns previously identified with said power company; and
communicating said random generic usage pattern comprises generating said random generic usage pattern.

15. A security method as in claim 12, wherein periodically communicating said delta comprises modulating said selected generic usage pattern with said delta in time and magnitude, and extracting said periodically communicated deltas comprises modulating said selected generic usage pattern.

16-25. (canceled)
